(19) United States
(12) Patent Application Publication
(10) Pub. No.: US 2024/0198848 A1
(43) Pub. Date: Jun. 20, 2024

(54) PREDICTING CHARGING BEHAVIOR OF ELECTRIC VEHICLE DRIVERS

(71) Applicant: INTERNATIONAL BUSINESS MACHINES CORPORATION, Armonk, NY (US)

(72) Inventors: Michael S. Gordon, Chappaqua, NY (US); Kommy Weldemariam, Ottawa (CA); Aisha Walcott, Nairobi (KE); Julian Bertram Kuehnert, Nairobi (KE); Steven Cordes, Yorktown Heights, NY (US)

(21) Appl. No.: 18/082,644

(22) Filed: Dec. 16, 2022

(51) Int. Cl. B60L 58/10; B60L 53/60; B60W 40/08

(52) U.S. Cl. CPC B60L 58/10; B60L 53/60; B60W 40/08; B60L 2250/00; B60W 2540/22

(57) ABSTRACT

A computer-implemented method for predicting electric vehicle (EV) charging behavior of a driver. The method includes predicting when an EV needs to be charged, where the EV needs to be charged, and for how long the EV needs to be charged based on individualized characteristics of the driver or one or more passengers, weather conditions, and geospatial characteristics. The method further includes evaluating an availability of one or more EV charging stations located within a given radius of the EV and comparing a location of the one or more available EV charging stations, located within the given radius of the EV, to one or more desired locations of the driver of the EV. The method further includes determining an estimated waiting time at the one or more EV charging stations and scheduling an EV charging time at the one or more EV charging stations, based on the location and duration.

### BACKGROUND

The present disclosure relates generally to the field of cognitive computing, machine learning, and more particularly to data processing and predicting best available options for charging of electric vehicles (EVs) while driving.

The global electric vehicle market value is projected to reach $567,300 million by 2025. However, “range anxiety” is a key factor affecting a consumer's decision to buy an EV. “Range anxiety” is a driver's concern that their EV will not have enough battery charge to reach their destination.

J.D. Power's EV survey finds that “[a]vailable public-charging infrastructure was the third key factor in EV enjoyment. While charging and range are often the biggest worries about EVs among non-owners, those who actually operate the EV cars quickly learn the vast majority of their miles come from overnight charging at home or charging at work during the day.”

The density of publicly available level 2 (or fast) chargers across the United States are found mostly in areas of large cities (e.g., New York City, Los Angeles, Boston, Denver, Houston, Chicago, etc.)

Unlike traditional gas stations where a driver can fill up their gas tank in a matter of minutes, drivers of EVs may need to spend quite a bit of time at a charging station depending on how far away the driver's destination is and how much charge is required to get there. Furthermore, not knowing how long an EV will be charging at a charging station affects the time schedule of other drivers who may have to wait until a charging “pump” is available for use.

Current technology allows drivers to see if charging stations are currently available. However, EV drivers need to know where, when, and for how long they can charge their vehicle.

### SUMMARY

Embodiments of the present invention disclose a method, a computer program product, and a system for determining consumer demand at EV charging stations to help eliminate predicted “range anxiety” in drivers.

A method, according to an embodiment of the invention, in a data processing system including a processor and a memory. The method includes predicting when an EV needs to be charged, where the EV needs to be charged, and for how long the EV needs to be charged based on individualized characteristics of the driver or one or more passengers, weather conditions, and geospatial characteristics. The method further includes evaluating an availability of one or more EV charging stations located within a given radius of the EV and comparing a location of the one or more available EV charging stations, located within the given radius of the EV, to one or more desired locations of the driver of the EV. The method further includes determining an estimated waiting time at the one or more EV charging stations and scheduling an EV charging time at the one or more EV charging stations, based on the location and duration.

A computer program product, according to an embodiment of the invention, includes a non-transitory tangible storage device having program code embodied therewith. The program code is executable by a processor of a computer to perform a method. The method includes predicting when an EV needs to be charged, where the EV needs to be charged, and for how long the EV needs to be charged based on individualized characteristics of the driver or one or more passengers, weather conditions, and geospatial characteristics. The method further includes evaluating an availability of one or more EV charging stations located within a given radius of the EV and comparing a location of the one or more available EV charging stations, located within the given radius of the EV, to one or more desired locations of the driver of the EV. The method further includes determining an estimated waiting time at the one or more EV charging stations and scheduling an EV charging time at the one or more EV charging stations, based on the location and duration.

A computer system, according to an embodiment of the invention, includes one or more computer devices each having one or more processors and one or more tangible storage devices; and a program embodied on at least one of the one or more storage devices, the program having a plurality of program instructions for execution by the one or more processors. The program instructions implement a method. The method includes predicting when an EV needs to be charged, where the EV needs to be charged, and for how long the EV needs to be charged based on individualized characteristics of the driver or one or more passengers, weather conditions, and geospatial characteristics. The method further includes evaluating an availability of one or more EV charging stations located within a given radius of the EV and comparing a location of the one or more available EV charging stations, located within the given radius of the EV, to one or more desired locations of the driver of the EV. The method further includes determining an estimated waiting time at the one or more EV charging stations and scheduling an EV charging time at the one or more EV charging stations, based on the location and duration.

### BRIEF DESCRIPTION OF THE DRAWINGS

FIG. 1 depicts a diagram graphically illustrating the hardware components of electric vehicle (EV) charging scheduler environment 100 and a cloud computing environment, in accordance with an embodiment of the present invention.

FIG. 2 illustrates electric vehicle (EV) charging scheduler computing environment 200, in accordance with an embodiment of the present invention.

FIG. 3 is a flowchart illustrating the operation of electric vehicle (EV) charging scheduler program 220 of FIG. 2, in accordance with an embodiment of the present invention.

### DETAILED DESCRIPTION

A new metric has been established for charging EVs. In the context of “miles per hour” or “range per hour”, EV mileage is measured by the number of driving miles available “per hour of charging”. As described on Ford's website, there are various levels of electric charging for EVs. Level 1 charging can charge at a rate of about 1.4 kW and provides about 3 miles of driving per hour of charging. Level 2 charging can charge at a rate of about 7.2 kW and provides about 20 miles of driving per hour of charging. Ford offers a “connected share station” which allows for charging at home with 240V and 48 A and can charge at a rate of about 11.5 kW and provides about 28 miles of driving per hour of charging.

As one can see, the rate of charging EVs depends on the available infrastructure. EV owners, for the most part, charge their vehicles when they are home. However, EV owners need to use charging stations for long trips, which can lead to “range anxiety”. “Range anxiety” occurs when EV owners worry about running out of charge before locating a charging station or arriving at their desired destination.

Since most of the publicly available level 2 (or fast) chargers are located around large cities, an EV driver may think twice before taking a road trip. Some variables affecting an EV driver's decision may include: the current battery level of the EV; the distance to the planned destination; the EV driver's schedule (does the driver need to be somewhere soon?); the cost of charging; unpredictability of having to wait at a charging station until a “pump” is available; unpredictability of the number of other EV drivers that may also need to charge their EV at the same time; the history of a person's charging behavior; and the level (or speed) of the charging stations along the way.

Current technology only allows drivers to see if pumps are currently available, but EV drivers, or self-driving electric vehicles (SDEVs), have no knowledge of the predicted demand, or when a “pump” will become available. This uncertainty is a cause for anxiety.

To reduce this “range anxiety”, EV drivers, or occupants of SDEVs, need to charge their vehicle, or know that they can charge their vehicle at a certain time and location.

Currently, there is no technology that uses machine learning (ML) models to estimate, or predict, potential “range anxiety” for EV drivers, or occupants of SDEVs, and establish a causal relation of the predicted “range anxiety” with health or behavioral concerns, and further generating actionable amelioration alerts to the EV driver, or occupants of SDEVs.

As such, there is a need for a system and method that facilitates charging EVs (where, when, and for how long) by predicting the demand for charging stations while minimizing undesired consequences due to predicted “range anxiety”. Additionally, a novel method in which the EV driver, or occupants of EVs and SDEVs, can be sure that they are able to charge their vehicle is critical.

The present disclosure discloses a novel system and method for predicting the charging behavior of individuals driving EVs, which can be used to determine demand at charging stations and help to eliminate predicted “range anxiety” in EV drivers and occupants of SDEVs.

Hereinafter, exemplary embodiments of the present disclosure will be described in detail with reference to the attached drawings.

The present disclosure is not limited to the exemplary embodiments below, but may be implemented with various modifications within the scope of the present disclosure. In addition, the drawings used herein are for purposes of illustration, and may not show actual dimensions.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

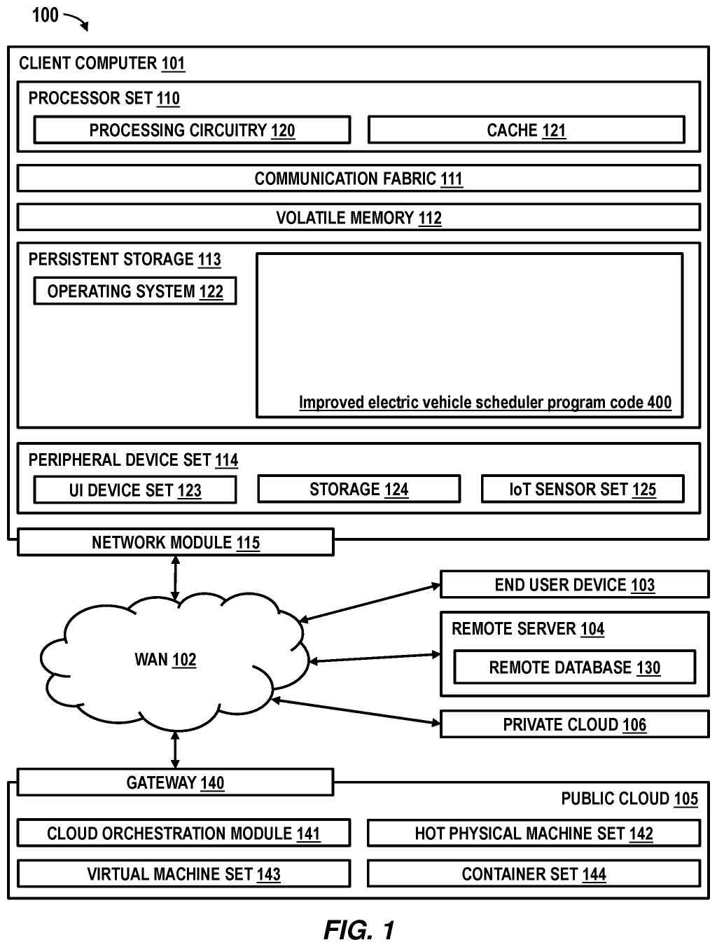

FIG. 1 depicts a diagram graphically illustrating the hardware components of electric vehicle charging scheduler computing environment 100 and a cloud computing environment in accordance with an embodiment of the present invention.

Electric vehicle charging scheduler computing environment 100 contains an example of an environment for the execution of at least some of the computer code involved in performing the inventive methods, such as improved electric vehicle charging scheduler program code 400. In addition to the improved electric vehicle charging scheduler program code 400, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and improved electric vehicle charging scheduler program code 400, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in improved electric vehicle charging scheduler program code 400 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open-source Portable Operating System Interface type operating systems that employ a kernel. The code included in improved electric vehicle charging scheduler program code 400 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

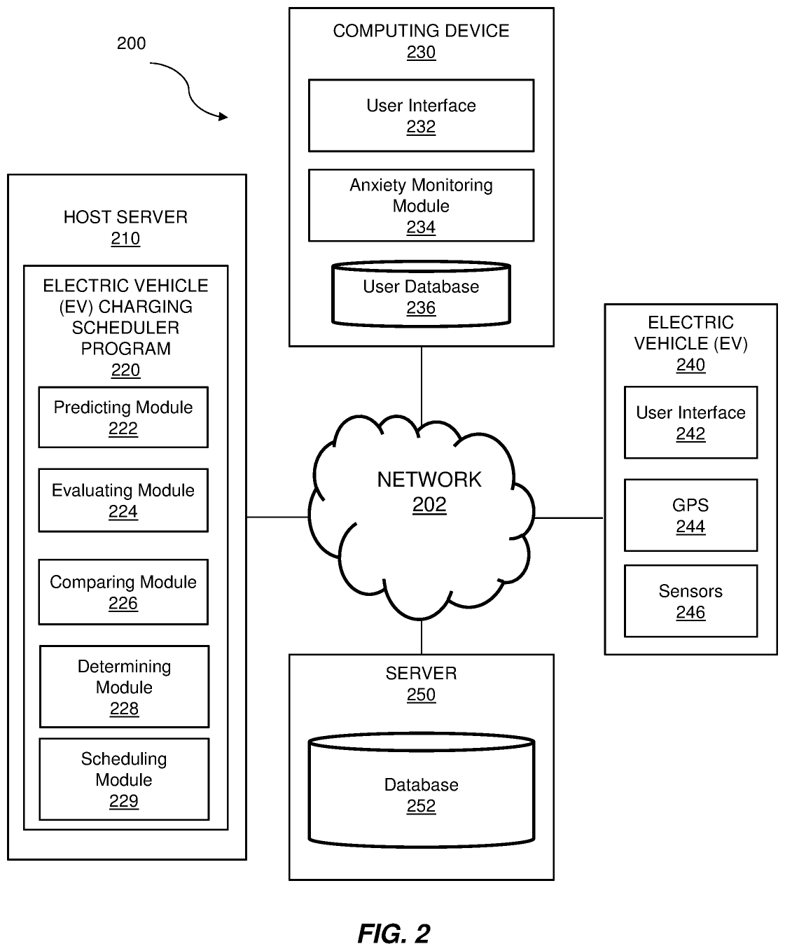

FIG. 2 illustrates an electric vehicle (EV) charging scheduler computing environment 200, in accordance with an embodiment of the present disclosure. EV charging scheduler computing environment 200 includes host server 210, computing device 230, electric vehicle 240, and server 250 all connected via network 202. The setup in FIG. 2 represents an example embodiment configuration for the present disclosure and is not limited to the depicted setup to derive benefit from the present disclosure.

In an exemplary embodiment, host server 210 includes electric vehicle (EV) charging scheduler program 220. In various embodiments, host server 210 may be a laptop computer, tablet computer, netbook computer, personal computer (PC), a desktop computer, a personal digital assistant (PDA), a smart phone, a server, or any programmable electronic device capable of communicating with computing device 230, electric vehicle 240, and server 250 via network 202. Host server 210 may include internal and external hardware components, as depicted, and described in further detail with reference to FIG. 1. In other embodiments, host server 210 may be implemented in a cloud computing environment, as further described in relation to FIG. 1 herein. Host server 210 may also have wireless connectivity capabilities allowing the host server 210 to communicate with computing device 230, EV 240, server 250, and other computers or servers over network 202.

With continued reference to FIG. 2, computing device 230 includes user interface 232 and, anxiety monitoring module 234, and user database 236. In various embodiments, computing device 230 may be a laptop computer, tablet computer, netbook computer, personal computer (PC), a desktop computer, a personal digital assistant (PDA), a wearable device, a smart phone, a smart watch, or any programmable electronic device capable of communicating with host server 210, EV 240, and server 250 via network 202. Computing device 230 may include internal and external hardware components, as depicted, and described in further detail with reference to FIG. 1. In other embodiments, computing device 230 may be implemented in a cloud computing environment, as described in relation to FIG. 1, herein. Computing device 230 may also have wireless connectivity capabilities allowing it to communicate with host server 210, EV 240, server 250, and other computers or servers over network 202.

In exemplary embodiments, computing device 230 includes user interface 232, which may be a computer program that allows a user to interact with computing device 230 and other connected devices via network 202. For example, user interface 232 may be a graphical user interface (GUI). In addition to comprising a computer program, user interface 232 may be connectively coupled to hardware components, such as those depicted in FIG. 1, for receiving user input. In an exemplary embodiment, user interface 232 may be a web browser, however in other embodiments user interface 232 may be a different program capable of receiving user interaction and communicating with other devices.

In exemplary embodiments, computing device 230 includes anxiety monitoring module 234, which includes sensors that can detect and monitor a user's health and behavioral characteristics which may include blood pressure, blood sugar levels, heart rate, word spoken or recorded and so on. In other embodiments, anxiety monitoring module 234 may be a separate device such as a heart rate monitor or a wearable device that detects a user's anxiety level and communicates with computing device 230.

Anxiety monitoring module 234 can transmit detected and monitored anxiety levels of a user to EV charging scheduler program 220, either on a continuous basis or at set intervals. In other embodiments, anxiety monitoring module 234 may be configured to detect and monitor a user's anxiety level based on any method known to one of ordinary skill in the art. In exemplary embodiments, anxiety monitoring module 234 may include an opt-in feature, enabling a user to set preferences (e.g., give or revoke permissions) for detection, monitoring, and storing of a user's privately collected medical data.

While anxiety monitoring module 234 is depicted as being stored on computing device 230, in other embodiments, anxiety monitoring module 234 may be stored on host server 210, EV 240, server 250, or any other device connected via network 202, as a separate module.

In exemplary embodiments, computing device 230 includes user database 236, which includes individualized information about one or more EV drivers, or occupants. Examples of individualized data may include: an e-calendar with scheduled appointments and meetings; individualized preferences (e.g., preferred routes such as local roads, no tolls, avoidance of roads with a speed limit greater than 65 miles per hour, etc.), preferred charging methods (e.g., cost efficiency, charging speed, etc.); EV and Self driving electric vehicles (SDEV) constraints (e.g., battery capacity, energy consumption, battery lifetime, charging rate limitations); and previous experiences/events of a user concerning EV charging stations, anxiety levels, and reaching a destination.

In further exemplary embodiments, database 252 may include one or more sets of data, mapped to a database table, corresponding to collected battery level data of EV 240, an amount of time until the battery of EV 240 is in critical need of a charge, a number of miles that EV 240 can drive (without traffic) until the battery needs to be charged, an amount of time that EV 240 idles in traffic until the battery needs to be charged, preferences of a driver of EV 240 for when battery of EV 240 is to be charged, and whether EV 240 will make it to its desired destination with any excess charge, and so forth.

While database 252 is depicted as being stored on server 250, in other embodiments, database 252 may be stored on host server 210, EV 240, or any other device or database connected via network 202, as a separate database. In alternative embodiments, database 252 may be comprised of a cluster or plurality of computing devices, working together, or working separately.

With continued reference to FIG. 2, EV 240 includes user interface 242, global positioning system (GPS) 244, and sensors 246. In exemplary embodiments, EV 240 may include, but is not limited to, a car, a minivan, a bus, a truck, a tractor-trailer, a train, or any road (or off-road) vehicle.

In an exemplary embodiment, EV 240 includes user interface 242 which may be a computer program that allows a user to interact with EV 240 and other connected devices via network 202. For example, user interface 242 may be a graphical user interface (GUI). In addition to comprising a computer program, user interface 242 may be connectively coupled to hardware components, such as those depicted in FIG. 1, for sending and receiving data. In an exemplary embodiment, user interface 242 may be a web browser, however in other embodiments user interface 242 may be a different program capable of receiving user interaction and communicating with other devices, such as host server 210, computing device 230, and server 250.

In exemplary embodiments, user interface 242 may be presented on a touch screen display, a remote operated display, or a display that receives input from a physical keyboard or touchpad located within EV 240, such as on the dashboard, console, etc. In alternative embodiments, user interface 242 may be operated via voice commands, Bluetooth® (Bluetooth and all Bluetooth-based trademarks and logos are trademarks or registered trademarks of Bluetooth SIG, Inc. and/or its affiliates), a mobile device that connects to EV 240, or by any other means known to one of ordinary skill in the art. In exemplary embodiments, a user may interact with user interface 242 to transmit a message, wherein the message is in the form of audio data, video data, image data, text data, and so forth. In various embodiments, a user may interact with user interface 242 to provide user feedback to EV charging scheduler program 220, via network 202.

In exemplary embodiments user interface 242 is the primary communication module that communicates with an EV driver the scheduled/recommended EV charging time, duration, and location. An EV driver may update individualized preferences in real-time via user interface 242.

In exemplary embodiments, global positioning system (GPS) 244 is a computer program on EV 240 that provides time and location information for a vehicle. Modern GPS systems operate on the concept of time and location. In modern GPS systems, four or more satellites broadcast a continuous signal detailing satellite identification information, time of transmission (TOT), and the precise location of the satellite at the time of transmission. When a GPS receiver picks up the signal, it determines the difference in time between the time of transmission (TOT) and the time of arrival (TOA). Based on the amount of time it took to receive the signals and the precise locations of the satellites when the signals were sent, GPS receivers can determine the location where the signals were received. In the exemplary embodiment, GPS 244 can provide real-time location information of EV 240, together with an estimated time of arrival for a given destination based on real-time traffic, weather conditions, and so forth. GPS 244 may also include alternate routes to reach a destination. In exemplary embodiments, GPS 244 may direct EV 240 to a route that includes a closer charging station, a less crowded charging station, or a charging station where the driver has a charging appointment, based on results of EV charging scheduler program 220.

In exemplary embodiments, GPS 244 is located in EV 240 and may include real-time information regarding traffic, emergency happenings on a route (i.e., car accident, bridge collapse, fire, etc.) or public events (i.e., sporting events, concerts) that may affect estimated travel time information. In various embodiments, GPS 244 may provide alternate routes to reach a destination.

In exemplary embodiments, EV 240 includes one or more sensors 246. Sensors 246 may be a device, hardware component, module, or subsystem capable of recording, capturing, and detecting events or changes in EV 240 and sending the detected data to other electronics (e.g., host server 210), components (e.g., database 252), or programs (e.g., EV charging scheduler program 220) within a system (e.g., EV charging scheduler computing environment 200). In various embodiments, the detected data collected by sensors 246 may be instrumental in providing feedback to EV charging scheduler program 220.

Sensors 246, in exemplary embodiments, may be located within EV 240 and may be a software application, proximity sensor, camera, microphone, light sensor, infrared sensor, weight sensor, magnetic ring sensor, temperature sensor, barometric pressure sensor, tactile sensor, motion detector, optical character recognition (OCR) sensor, occupancy sensor, heat sensor, analog sensor (e.g., potentiometers, force-sensing resistors), radar, radio frequency sensor, quick response (QR) code, video camera, digital camera, Internet of Things (IoT) sensors, lasers, gyroscopes, accelerometers, actuators, structured light systems, tracking sensors, and other devices used for measuring, detecting, recording an environment or current state of the EV 240 and/or components/systems of the EV 240.

In exemplary embodiments, sensors 246 are capable of continuously monitoring, collecting, and saving collected data on a local storage or storage on a separate server (e.g., database 252), or alternatively sending the collected data, or various selected pieces of the collected data, to EV charging scheduler program 220.

In exemplary embodiments, sensors 246 can measure various systems/components of EV 240 in real-time, such as electric battery level, predicated arrival time to a destination, predicted route to get to a destination, whether the predicted route includes electric charging stations, predicted traffic congestion along the route, and so forth.

In alternative embodiments, sensors 246 may be capable of detecting, communicating, pairing, or syncing with internet of things (IoT) devices, thus creating opportunities for more direct integration of the physical world into computer-based systems, and resulting in improved efficiency, accuracy, and economic benefit in addition to reduced human intervention.

In various embodiments, sensors 246 are embedded within EV 240 that contain a computer processing unit (CPU), memory, and power resource, and may be capable of communicating with EV 240, host server 210, computing device 230, and server 250 over network 202.

In exemplary embodiments, sensors 246 continually monitor the components of EV 240 (e.g., battery level) and transmit the collected data to EV charging scheduler program 220.

In an exemplary embodiment, server 250 includes database 252. In various embodiments, server 250 may be a laptop computer, tablet computer, netbook computer, personal computer (PC), a desktop computer, a personal digital assistant (PDA), a smart phone, a server, or any programmable electronic device capable of communicating with host server 210, electric vehicle 240, and computing device 230 via network 202. Server 250 may include internal and external hardware components, as depicted, and described in further detail with reference to FIG. 1. In other embodiments, server 250 may be implemented in a cloud computing environment, as described in relation to FIG. 1, herein. Server 250 may also have wireless connectivity capabilities allowing the server 250 to communicate with host server 210, electric vehicle 240, computing device 230, and other computers or servers over network 202.

In exemplary embodiments, database 252 may contain static data and dynamic data. Examples of static data include charging station networks, maps of streets and highways, and points of interest (e.g., restaurants, shopping malls, home address, work address, and so forth). Examples of dynamic data include real-time disruptions (e.g., construction sites along a roadway, highway closures, flooded streets, closed charging stations, availability and unavailability of chargers, and so forth).

In further exemplary embodiments, database 252 may include one or more sets of data, mapped to a database table, corresponding to collected battery level data of EV 240, an amount of time until the battery of EV 240 is in critical need of a charge, a number of miles that EV 240 can drive (without traffic) until the battery needs to be charged, an amount of time that EV 240 idles in traffic until the battery needs to be charged, predicted location of EV 240 where it will need to be charged, preferences of a driver of EV 240 for when battery of EV 240 is to be charged, and so forth.

While database 252 is depicted as being stored on server 250, in other embodiments, database 252 may be stored on host server 210, EV 240, or any other device or database connected via network 202, as a separate database. In alternative embodiments, database 252 may be comprised of a cluster or plurality of computing devices, working together or working separately.

With continued reference to FIG. 2, EV charging scheduler program 220, in an exemplary embodiment, may be a computer application on host server 210 that contains instruction sets, executable by a processor, that predicts charging behavior of EV drivers, or occupants. The instruction sets may be described using a set of functional modules. In exemplary embodiments, EV charging scheduler program 220 may receive input from computing device 230, EV 240, as well as additional EVs on a roadway, via network 202. In alternative embodiments, EV charging scheduler program 220 may be a computer application contained within EV 240, or a standalone program on a separate electronic device.

With continued reference to FIG. 2, the functional modules of EV charging scheduler program 220 include predicting module 222, evaluating module 224, comparing module 226, determining module 228, and scheduling module 229.

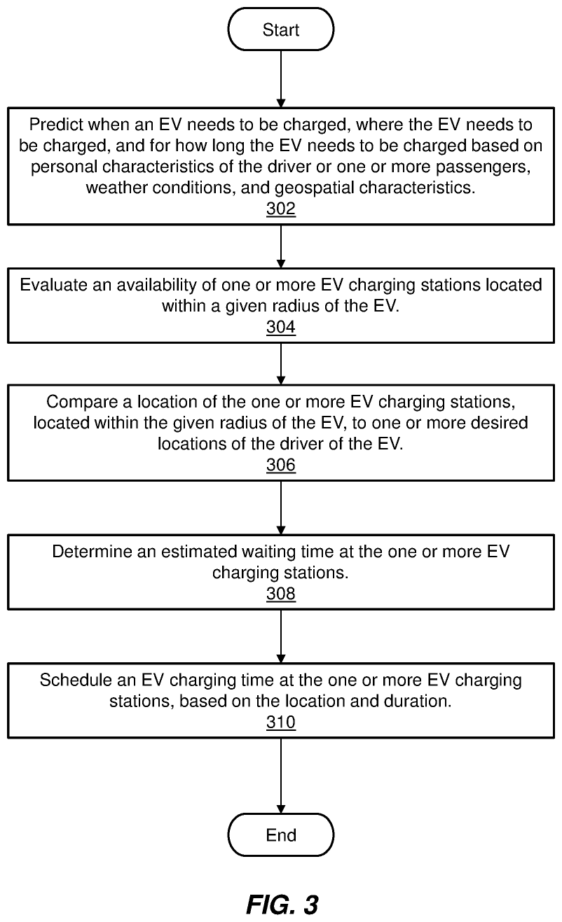

FIG. 3 is a flowchart illustrating the operation of EV charging scheduler program 220 of FIG. 2, in accordance with embodiments of the present disclosure.

With reference to FIGS. 2 and 3, predicting module 222 includes a set of programming instructions in EV charging scheduler program 220, to predict when an EV needs to be charged, where the EV needs to be charged, and for how long the EV needs to be charged based on individualized characteristics of the driver or one or more passengers, weather conditions, and geospatial characteristics (step 302). The set of programming instructions is executable by a processor.

In exemplary embodiments, a battery level indicates the amount of charge remaining in the battery of EV 240. For example, the battery level may indicate a percentage of battery charge remaining (e.g., 25%, 50%, 75%, etc.), an amount of time until the battery of EV 240 is at a 0% charge (e.g., 20 minutes, 1 hour, 3 hours, etc.), or any other metric, known to one of ordinary skill in the art, that is capable of communicating the amount of charge remaining in the battery of EV 240.

In exemplary embodiments, a destination is input by a user of the EV 240 into a mapping application to determine a route to the destination. Via GPS 244, the mapping application is capable of further depicting a current position of EV 240, a predicated arrival time of EV 240 to the destination, the predicted battery level at the destination. and any other information that is commonly conveyed to a user of an EV 240 while driving (e.g., traffic congestion, accidents, police, and so forth).

In various embodiments, predicting module 222 is further capable of identifying charging stations that are along the route to the destination, and may further divert the travel route of the EV 240 to one of the charging stations based on necessity (e.g., battery charge is dangerously low).

In exemplary embodiments, EV charging scheduler program 220 enables opt-in modeling of EV charging behavior per EV driver. For those EVs that have opted-in, EV charging scheduler program 220 trains a model to predict when the EV 240 will charge, where the EV 240 will charge, and for how long the EV 240 will charge. This can be done with both individualized and environmental context, including individualized calendars (e.g., from user database 236) for the driver and passengers, current and future weather conditions, and geospatial characteristics (e.g., the route to the charging station).

In alternative exemplary embodiments, EV charging scheduler program 220 may help to better understand EV charging practices of individual users, which may then be used to improve the offered services of charging stations. In turn, new charging station networks may be designed around these EV charging practices or services at existing charging stations may be extended.

In exemplary embodiments, predicting module 222 may train a machine learning model to predict potential “range anxiety” for the driver, or the one or more passengers, of the EV. Predicting module 222 may further establish that the “range anxiety” is a causal relation with health or behavioral concerns of the driver, or the one or more passengers, of the EV 240.

EV charging scheduler 220 may trigger an amelioration action when the predicted “range anxiety” is above a given threshold. The amelioration action may include generating an actionable alert to the driver, or the one or more passengers, to charge the EV 240 at a specific location, at a specific time, and for a specific duration.

In exemplary embodiments, predicting module 222 may train a machine learning model to predict possible idle time of the EV at a given time of day and determine optimal charging parameters (charging location, duration of charge, and time of charge), while minimizing operation downtime of the EV 240.

In further exemplary embodiments, the predicted charging information of the EV 240 automatically creates a calendar event, for the driver, with detailed metadata of the predicted charging event (location, duration).

With continued reference to FIGS. 2 and 3, evaluating module 224 includes a set of programming instructions in EV charging scheduler program 220 to evaluate an availability of one or more EV charging stations located within a given radius of the EV 240 (step 304). The set of programming instructions are executable by a processor.

In exemplary embodiments, evaluating module 224 pertains to those EV drivers that have opted-in by training a geospatial-enabled machine learning (ML) model using data sets of the user from historical EV charging events, weather forecast, an inferred driver/occupant of the EV and associated EV charging behavior of the driver and/or occupants, and predicted context (e.g., stress due to charging anxiety, calendar events, and so forth).

In alternative embodiments, evaluating module 224 can predict possible idle or less busy times of the day to determine an optimal location, time, and duration for a passenger EV (e.g., taxi or carpool) to charge, while minimizing service down-time of the EV and charging costs.

In exemplary embodiments, based on predicted charging of a location, time, and duration, an EV driver (or occupants of an SDEV) can automatically schedule the charging location, time, and duration via an AI-enabled e-booking system to facilitate (i.e., schedule, recommend, etc.) real-time EV, or SDEV, charging.

In alternative embodiments, EV charging scheduler program 220 may be used to support a points-based incentive program whereby EV drivers can gain points if they “give up” their charging time slot to another EV 240. This can be done through a crowd-sharing system and may be used to ensure that a charging time slot will be available at a specific charging station of interest, in the future. These points may be monetized/used by retail shops within charging stations, insurance, etc. The EV driver may be able to use points to buy a charging time slot for a specific period of time to guarantee that the time slot will be available at the desired time (and location) that the EV driver wants to charge.

With continued reference to FIGS. 2 and 3, comparing module 226 includes a set of programming instructions in EV charging scheduler program 220, to compare a location of the one or more available EV charging stations, located within the given radius of the EV 240, to one or more desired locations of the driver of the EV 240 (step 306). The set of programming instructions is executable by a processor.

In exemplary embodiments, desired locations of the EV driver may include shops, restaurants, gyms, parks, and so forth and may further depend on the time of day. For example, if the EV driver needs to stop to charge EV 240 during lunch time, it would be convenient if there was an available charging station near one of the EV driver's favorite restaurants.

In exemplary embodiments, comparing module 226 optimizes the predicted charging of the EV 240 based on economic costs and EV charging factors. Comparing module 226 may further recommend a cost-effective EV charging, wherein the EV charging factors comprise a charging time, a charging location, a charger type and emission, a route, and health and behavioral concerns of the driver, or the one or more passengers.

In alternative embodiments, EV charging scheduler program 220 can train a modular neural network for a joint analysis of predicting an EV charging station and output of a weather-impact analysis (e.g., whether there is a connectivity between charging station A and a current location of EV 240, or SDEV, given a road network masked by a flooded area) to determine optimal EV charging factors.

With continued reference to FIGS. 2 and 3, determining module 228 includes a set of programming instructions in EV charging scheduler program 220, to determine an estimated waiting time at the one or more EV charging stations (step 308). The set of programming instructions is executable by a processor.

In exemplary embodiments, determining module 228 determines if the EV 240 needs to wait for a charging station. If any of the nearby charging stations are full, determining module can model, or estimate, the wait time using a Poisson arrival process. A Poisson process is a model for a series of discrete events where the average time between events is known, but the exact timing of events is random. One needs to utilize the Poisson distribution process to find the probability of waiting some time until the next event (i.e., when a car leaves a charging station).

In the case of estimating wait times at charging stations, the temporal events are when a car leaves a full charging station, and the aim is to estimate the wait times. This can be done with average arrival times from the individualized EV trained model derived from predicting module 222.

With continued reference to FIGS. 2 and 3, scheduling module 229 includes a set of programming instructions in EV charging scheduler program 220, to schedule an EV charging time at the one or more EV charging stations, based on the location and duration (step 310). The set of programming instructions is executable by a processor.

In exemplary embodiments, EV charging scheduler program 220 may be used to schedule and recommend the most cost-effective EV charging method, including the following parameters: time, location, and charger type (e.g., charger speed level, shared, etc.).

In exemplary embodiments, scheduling module 229 may consider charging prices that may vary by time of day, geographic area, and demand. Similarly, other preferences of EV owners may be considered, such as charging stations that offer “green” electricity (e.g., powered exclusively by solar energy). This may be done using multi-objective optimization functions.

In exemplary embodiments, scheduling module 229 may use various approaches to schedule and recommend cost-effective charging methods. One approach may include performing a Pareto analysis between economic costs and charging factors (e.g., charging time, location, charger type, emission, etc.). Another approach may include assigning upfront monetary charging factors and jointly optimizing for economic costs and charging factors (e.g., charging time, location, and charger type).

In exemplary embodiments, EV charging scheduler program 220 can stop the EV charging when an actual charge level exceeds a predicted charge level required, by a predetermined amount, to reach a desired location.

In further exemplary embodiments, EV charging scheduler program 220 discloses an AI-enabled e-booking system to facilitate (i.e., schedule, recommend, etc.) real-time EV, or SDEV, charging. The AI-enabled e-booking system can profile every charging station with geospatial and temporal data and enable tracking for every charging event. The event data may then be used to predict locations where EV charging stations, both temporary and permanent stations, are needed or removed.

In further exemplary embodiments, EV charging scheduler program 220 can be used in EV trip planners to optimize the route, timing, and breaks depending on the EV driver's schedule and preferences, such as cost efficiency, trip duration, and stops (e.g., overnight stays, restaurants, sightseeing, etc.). Car rental or car-sharing companies can use the invention to offer special plans that allow EV drivers to switch from empty to fully charged vehicles on the go.

In exemplary embodiments, network 202 is a communication channel capable of transferring data between connected devices and may be a telecommunications network used to facilitate telephone calls between two or more parties comprising a landline network, a wireless network, a closed network, a satellite network, or any combination thereof. In another embodiment, network 102 may be the Internet, representing a worldwide collection of networks and gateways to support communications between devices connected to the Internet. In this other embodiment, network 202 may include, for example, wired, wireless, or fiber optic connections which may be implemented as an intranet network, a local area network (LAN), a wide area network (WAN), or any combination thereof. In further embodiments, network 202 may be a Bluetooth® network, a WiFi network, a vehicle-to-vehicle (V2V) network, a vehicle-to-infrastructure (V2I) network, a peer-to-peer (P2P) communication network, a mesh network, or a combination thereof. In general, network 202 can be any combination of connections and protocols that will support communications between host server 210, computing device 230, electric vehicle 240, and server 250.

1. A computer-implemented method for predicting electric vehicle (EV) charging behavior of a driver, the method comprising:
predicting when an EV needs to be charged, where the EV needs to be charged, and for how long the EV needs to be charged based on individualized characteristics of the driver or one or more passengers, weather conditions, and geospatial characteristics;
evaluating an availability of one or more EV charging stations located within a given radius of the EV;
comparing a location of the one or more available EV charging stations, located within the given radius of the EV, to one or more desired locations of the driver of the EV;
determining an estimated waiting time at the one or more EV charging stations;
scheduling an EV charging time at the one or more EV charging stations, based on the location and duration.

2. The computer-implemented method of claim 1, further comprising:
training a machine learning model to predict potential “range anxiety” for the driver, or the one or more passengers, of the EV; and
establishing that the “range anxiety” is a causal relation with health or behavioral concerns of the driver, or the one or more passengers, of the EV.

3. The computer-implemented method of claim 2, further comprising:
triggering an amelioration action when the predicted “range anxiety” is above a given threshold, wherein the amelioration action comprises generating an actionable alert to the driver, or the one or more passengers, to charge the EV at a specific location, at a specific time, and for a specific duration.

4. The computer-implemented method of claim 1, further comprising:
training a machine learning model to predict possible idle time of the EV at a given time of day; and
determining optimal charging parameters (location, duration, and time) while minimizing operation downtime of the EV.

5. The computer-implemented method of claim 1, wherein the predicted charging information of the EV automatically creates a calendar event, for the driver, with detailed metadata of the predicted charging.

6. The computer-implemented method of claim 1, further comprising:
optimizing the predicted charging of the EV based on economic costs and EV charging factors; and
recommending a cost-effective EV charging, wherein the EV charging factors comprise a charging time, a location, a charger type and emission, a route, and health and behavioral concerns of the driver, or the one or more passengers.

7. The computer-implemented method of claim 1, further comprising:
training a modular neural network for a joint analysis of predicting an EV charging station and output of a weather-impact analysis to determine optimal EV charging factors.

8. The computer-implemented method of claim 1, further comprising:
stopping the EV charging when an actual charge level exceeds a predicted charge level required, by a predetermined amount, to reach a desired location.

9. A computer program product, comprising a non-transitory tangible storage device having program code embodied therewith, the program code executable by a processor of a computer to perform a method, the method comprising:
predicting when an EV needs to be charged, where the EV needs to be charged, and for how long the EV needs to be charged based on individualized characteristics of the driver or one or more passengers, weather conditions, and geospatial characteristics;
evaluating an availability of one or more EV charging stations located within a given radius of the EV;
comparing a location of the one or more available EV charging stations, located within the given radius of the EV, to one or more desired locations of the driver of the EV;
determining an estimated waiting time at the one or more EV charging stations;
scheduling an EV charging time at the one or more EV charging stations, based on the location and duration.

10. The computer program product of claim 9, further comprising:
training a machine learning model to predict potential “range anxiety” for the driver, or the one or more passengers, of the EV; and
establishing that the “range anxiety” is a causal relation with health or behavioral concerns of the driver, or the one or more passengers, of the EV.

11. The computer program product of claim 10, further comprising:
triggering an amelioration action when the predicted “range anxiety” is above a given threshold, wherein the amelioration action comprises generating an actionable alert to the driver, or the one or more passengers, to charge the EV at a specific location, at a specific time, and for a specific duration.

12. The computer program product of claim 9, further comprising:
training a machine learning model to predict possible idle time of the EV at a given time of day; and
determining optimal charging parameters (location, duration, and time) while minimizing operation downtime of the EV.

13. The computer program product of claim 9, wherein the predicted charging information of the EV automatically creates a calendar event, for the driver, with detailed metadata of the predicted charging.

14. The computer program product of claim 9, further comprising:
optimizing the predicted charging of the EV based on economic costs and EV charging factors; and
recommending a cost-effective EV charging, wherein the EV charging factors comprise a charging time, a location, a charger type and emission, a route, and health and behavioral concerns of the driver, or the one or more passengers.

15. The computer program product of claim 9, further comprising:
training a modular neural network for a joint analysis of predicting an EV charging station and output of a weather-impact analysis to determine optimal EV charging factors.

16. A computer system, comprising:
one or more computer devices each having one or more processors and one or more tangible storage devices; and
a program embodied on at least one of the one or more storage devices, the program having a plurality of program instructions for execution by the one or more processors, the program instructions comprising instructions for:
predicting when an EV needs to be charged, where the EV needs to be charged, and for how long the EV needs to be charged based on individualized characteristics of the driver or one or more passengers, weather conditions, and geospatial characteristics;
evaluating an availability of one or more EV charging stations located within a given radius of the EV;
comparing a location of the one or more available EV charging stations, located within the given radius of the EV, to one or more desired locations of the driver of the EV;
determining an estimated waiting time at the one or more EV charging stations; and
scheduling an EV charging time at the one or more EV charging stations, based on the location and duration.

17. The computer system of claim 16, further comprising:
training a machine learning model to predict potential “range anxiety” for the driver, or the one or more passengers, of the EV; and
establishing that the “range anxiety” is a causal relation with health or behavioral concerns of the driver, or the one or more passengers, of the EV.

18. The computer system of claim 16, further comprising:
triggering an amelioration action when the predicted “range anxiety” is above a given threshold, wherein the amelioration action comprises generating an actionable alert to the driver, or the one or more passengers, to charge the EV at a specific location, at a specific time, and for a specific duration.

19. The computer system of claim 16, further comprising:
training a machine learning model to predict possible idle time of the EV at a given time of day; and
determining optimal charging parameters (location, duration, and time) while minimizing operation downtime of the EV.

20. The computer system of claim 16, wherein the predicted charging information of the EV automatically creates a calendar event, for the driver, with detailed metadata of the predicted charging.
